(19) United States
(12) Patent Application Publication
(10) Pub. No.: US 2006/0206818 A1
(43) Pub. Date: Sep. 14, 2006

(54) Dynamic frequently asked question system

(75) Inventors: Bill Utter, Lomita, CA (US); Moira Zucker, Manhattan Beach, CA (US); Carmen Maria Jercic, Rancho Palos Verdes, CA (US); Paula Itagaki, South San Gabriel, CA (US); James S. Morgan, Long Beach, CA (US); Albert Logiodice, Ladera Ranch, CA (US)

Correspondence Address: PILLSBURY WINTHROP SHAW PITTMAN LLP, P.O BOX 10500, McLean, VA, 22102, US

(73) Assignee: EPSON AMERICA INC., Long Beach, CA (US)

(21) Appl. No.: 11/076,596

(22) Filed: Mar. 10, 2005

(51) Int. Cl. G06F 9/00

(52) U.S. Cl. 715/705; 715/811; 715/738; 715/708

(57) ABSTRACT

A DFAQ system includes a computing device 130 and the computing device includes a reorganization module 132, a processor 134, a non-volatile memory 136 and a storage module 138 for web pages or active server pages. As a frequently asked question (FAQ) is accessed, a counter corresponding to the FAQ is incremented. The reorganization module determines the number of accesses for a plurality of FAQs after a pre-determined timeframe. The reorganization module creates a web page listing the plurality of FAQs based on the number of accesses for each of the plurality of FAQs and also based on one of an assigned default position, whether an access threshold value is reached, and weighted number of accesses.

### BACKGROUND OF THE INVENTION

1. Field of the Invention

The present invention relates generally to presentation of frequently asked questions (FAQs) in a graphical user interface (GUI). Specifically, the invention relates to a method and apparatus for organizing selectable elements on a GUI of a computing device in unique ways.

2. Description of the Prior Art

Many computer applications include graphical user interfaces (GUIs) to allow for easy access to data or programs. The GUI displays selectable elements or text strings on a display device. Examples of selectable elements or text strings include hypertext links or GUI buttons. The GUI including the selectable elements may be displayed on a display that is integral to a computing device or on a display separate or independent of the computing device. If a selectable element or text string is chosen or selected, under certain operating conditions, an underlying application running on the computing device may respond by providing information corresponding to the selected information. Under other operating conditions, the underlying application running on the computing device may respond by performing certain operations.

The organization of the selectable elements on a GUI allows a user of the underlying application to efficiently operate the underlying software application. A software application designer attempts to organize selectable elements in a logical manner to enable users to determine which element is to be selected. In the prior art, computer applications designers utilized surveys, focus groups, beta tests, or other similar techniques to determine which selectable elements on a GUI would be the most frequently accessed. After they determined which of the selectable elements were accessed most frequently, the computer designers utilized this information to organize the selectable elements on the GUI.

This approach has many drawbacks. This technique of organizing selectable elements on the GUI is static and does not dynamically change as the underlying software application or information evolves. In many cases, the organization of selectable elements on a GUI is fixed at the time the software application is developed. The lack of ability to dynamically change means that the selectable elements on the GUI may become outdated quickly. For example, in a web-based Frequently Asked Question system, a web server is continuously being accessed by consumers who purchase a certain manufacturer's products. New product information, update product information, safety information, or fixes for current products may need to provided or accessible to purchasers of a manufacturer's products. If the list of FAQs is frozen at the time the original support software application is developed, the new information is unavailable to the manufacturer's consumers. Accordingly, there is a need to develop a FAQ system that automatically and dynamically organizes the most frequently accessed FAQs in a manner that the manufacturer can control.

The current method for determining which questions are most frequently asked is inefficient and does not allow for the combination of listing the most frequently asked FAQs and also FAQs that the manufacturer wants to have displayed to the consumer, regardless of the number of accesses. In most cases, the determination of the most frequently accessed FAQs is performed manually. A representative of the manufacturer manually collects this information. This is tedious, time consuming, and may be subject to numerous human errors. If too many FAQ questions are listed, this also presents a problem to users because the user may need to investigate a large number of FAQs in order to find the desired FAQ and answer. If a sample size is small, it also may be difficult to determine the most efficient way of organizing the selectable elements (FAQs) to provide the most benefit to manufacturer's customers. Accordingly, a need exists to organize the FAQs in a manner that integrates listing by highest access frequency, listing in a default position, and not listing FAQs if an access threshold is not met.

### BRIEF DESCRIPTION OF THE DRAWINGS

FIG. 1 illustrates a dynamic frequently asked question system according to an embodiment of the present invention;

FIG. 2 illustrates a memory table for collecting number of accesses for each of the FAQs according to an embodiment of the present invention;

FIG. 3 illustrates a flowchart of operation of a Dynamic Frequently Asked Question (DFAQ) system according to an embodiment of the present invention;

FIG. 4 illustrates an Epson web page including a first area with a list of FAQs and a second area including categories;

FIG. 5 illustrates operation of a DFAQ system including a default setting position feature according to an embodiment of the present invention;

FIG. 6 illustrates a memory table including the default positions or pre-arranged positions;

FIG. 7 illustrates a DFAQ system including an access threshold according to an embodiment of the invention;

FIG. 8 illustrates a memory table including an access threshold according to an embodiment of the present invention;

FIG. 9 illustrates a DFAQ system including a weighting factor according to an embodiment of the present invention;

FIG. 10 illustrates a memory table including weighting factors according to an embodiment of the present invention;

FIG. 11 illustrates a DFAQ system including default positions and weighted number of accesses according to an embodiment of the invention; and

FIG. 12 illustrates a memory table including weighting factors and default values according to an embodiment of the present invention;

### DETAILED DESCRIPTION OF THE INVENTION

In order to simply discussion of the present invention, examples in this disclosure may discuss only FAQ listings. The concept disclosed in the patent application may be utilized in FAQ systems and also may be utilized for any computer software based applications utilizing GUIs which have selectable elements. Accordingly, the invention described is not limited to listings of FAQs.

A dynamic frequently asked question (DFAQ) system may provide for customizable listing of frequently asked questions (FAQs) on a graphical user interface (GUI) of a customer's computing device display. Illustratively, the customer may utilize a laptop computer, a personal digital assistant (PDA), a desktop computer, a handheld computer, a mainframe computer, or a terminal to login or enter a computing device, e.g., server, which houses the DFAQ system or DFAQ software application. The customer's computing device may communicate with the DFAQ system via a global communications network, such as the Internet. The customer's computing device may also communicate with the DFAQ system via a wireless network.

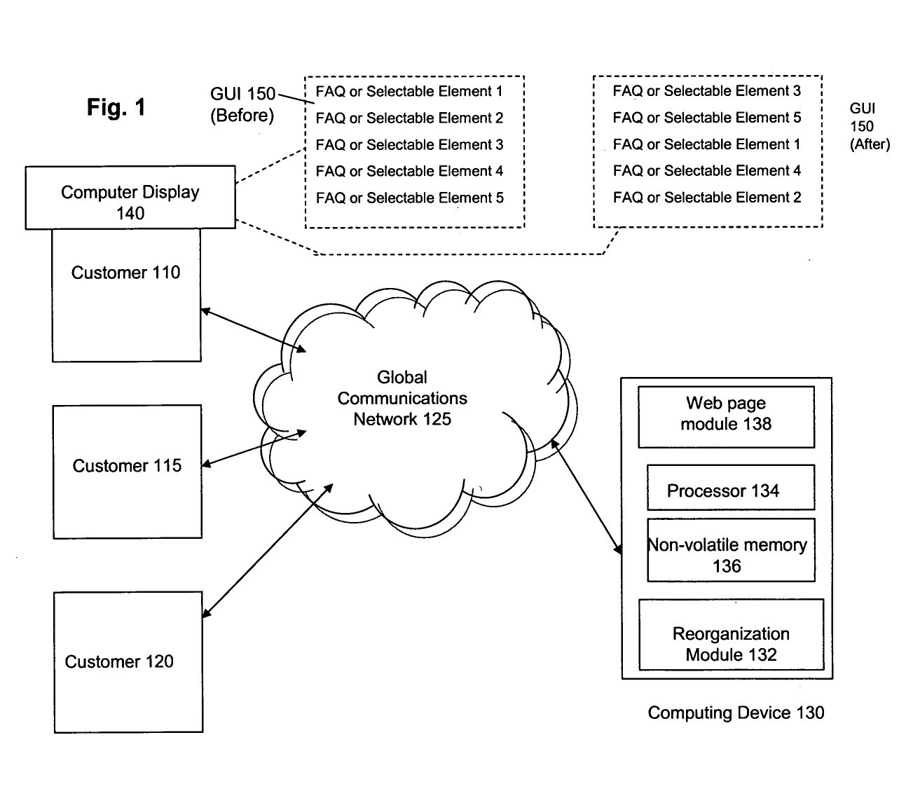

FIG. 1 illustrates a dynamic frequently asked question system 100 according to an embodiment of the present invention. The DFAQ system 100 may include a computing device 130. The computing device 130 may be a server that is accessible via a global communications network 125, such as the Internet. In an embodiment of the invention, the computing device 130 may be any computer (laptop, desktop, server, mini-computer, mainframe, etc.) that is located at a manufacturer's customer support center which is accessible via the Internet. The computing device 130 may include a reorganization module 132, a processor 134, and a non-volatile memory 136. The computing device 130 may also include a storage module 138 for web pages or active server pages. This may be referred to as a web page module or an active server page module. The web pages may be written in any markup language, such as Hyptertext Markup Language (HTML) and Extensible Markup Language (XML). Reference numeral 150 illustrates how one of the web pages may appear on a customer computing device display 140. Reference numeral 150 illustrates the appearance of FAQs on a display of a customer computing device display 140 before and after the operation of the present invention. The computing device 130 may not require a computer display.

Customers may interact with the DFAQ system 100 via customer computing devices 110, 115, and 120. The customer computing devices 110, 115, and 120 may be coupled to the DFAQ system computing device 130 via the global communications network 125. In other embodiments of the invention, the customer computing devices 110, 115, and 120 may be coupled to the computing device 130 of the DFAQ system via a local area network (LAN), a wide area network (WAN), or a wireless network. The networks may operate in a client—server fashion or in a peer-to-peer fashion. The customer computing devices 110, 115, and 120 may include customer displays. For ease of illustration, customer computing device 110 includes a computer display 140. A simple graphical user interface 150 for the customer computer display 140 is illustrated as reference numeral 150.

An initial list of selectable elements or frequently asked questions (FAQs) are created and stored as a web page, e.g., an active server page, a HTML page, or a XML page in the web page module 138. The web page is available for viewing by the customer computing devices 110, 115, and 120 via the global communications network 125. As the list of selectable elements are accessed by users of the customer computing devices 110, 115, and 120, a counter is incremented in the non-volatile memory 136 corresponding to the selected FAQ or selectable item. In an embodiment of the invention, the counter may be included in the reorganization module 132 or may be located separately in the computing device 130.

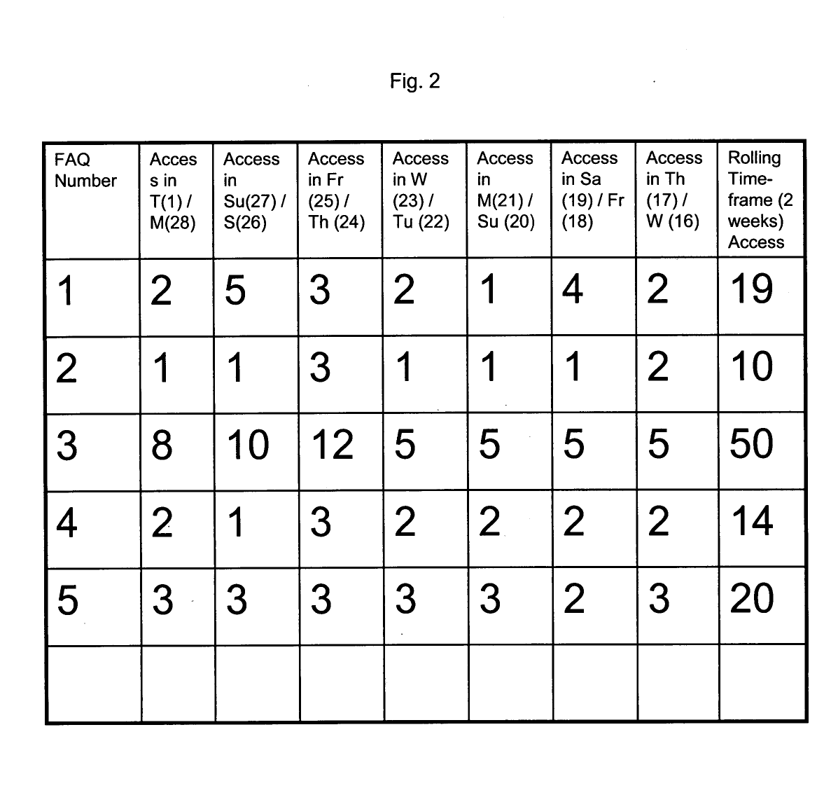

FIG. 2 illustrates a memory table for collecting number of accesses for each of the FAQs according to an embodiment of the present invention. In embodiments of the invention, the memory table 200 may be located in the non-volatile memory 136. The memory table 200 may also be located in another memory of the computing device 130. A memory table 200 is utilized to monitor the number of accesses of each of the selected FAQs. The memory table 200 illustrated in FIG. 2 includes a row for each of the displayed FAQs and columns (locations) for counting the number of accesses in predetermined timeframes and also columns (locations) for calculating a number of access for a rolling timeframe. Illustratively, a rolling timeframe may be two weeks. Each of the other predetermined timeframes may be two of the days in the rolling timeframe. For example, the second column could be the number of accesses in the 1^{st} week (Tuesday/Monday), the third column could be the number of accesses in the 1^{st} week for the previous two days (Sunday/Saturday), the fourth column could be the number of accesses in the in the previous two days (Friday/Thursday), and the fifth column could be the number of accesses in the previous two days (Wednesday of first week/Tuesday of second week). The sixth column could be the number of accesses in Monday/Sunday of the second week. The seventh column could be the number of accesses in Saturday/Friday of the second week and the eighth column could be the number of accesses in Thursday/Wednesday of the second week.

After the rolling timeframe, e.g,. two weeks, has elapsed, the reorganization module 132 may retrieve the number of accesses for each of the FAQ listings during the rolling timeframe. Under other operating conditions, the reorganization module 132 may retrieve the number of accesses for each of the FAQ listings during any of the measured pre-determined timeframes. The reorganization module 132 utilizes the number of accesses for each of the FAQs, (for example, the rolling timeframe) and re-organizes the listing of the FAQs on the web page in a decreasing or descending order based on the number of accesses. In other words, the FAQ being most frequently accessed is listed at the top of the web page and the FAQ being least frequently accessed is listed at the bottom of the web page. As illustrated in FIG. 2, based on the number of accesses during a rolling timeframe of two weeks, the reorganization module 132 would create a web page having FAQ3 (with 50 accesses) at the top, FAQ5 (with 20 accesses) next, FAQ1 (with 19 accesses) next, FAQ4 (with 14 accesses) next, and FAQ2 last. The web page may be stored in the web page module 138. The updated web page is then available for viewing. In order to keep monitoring a two-week rolling timeframe, the number of accesses in the oldest measuring timeframe can be replaced by a number of accesses in the newest measuring timeframe. For example, Wednesday and Tuesday of two weeks ago could be replaced by the number of accesses in this week's Tuesday and Wednesday.

When the next user, via a customer computing device 110, 115, or 120, attempts to access the web site (and thus the updated web page), the customer computing device 110, 115, or 120, would display the updated web page with the updated listing of FAQs.

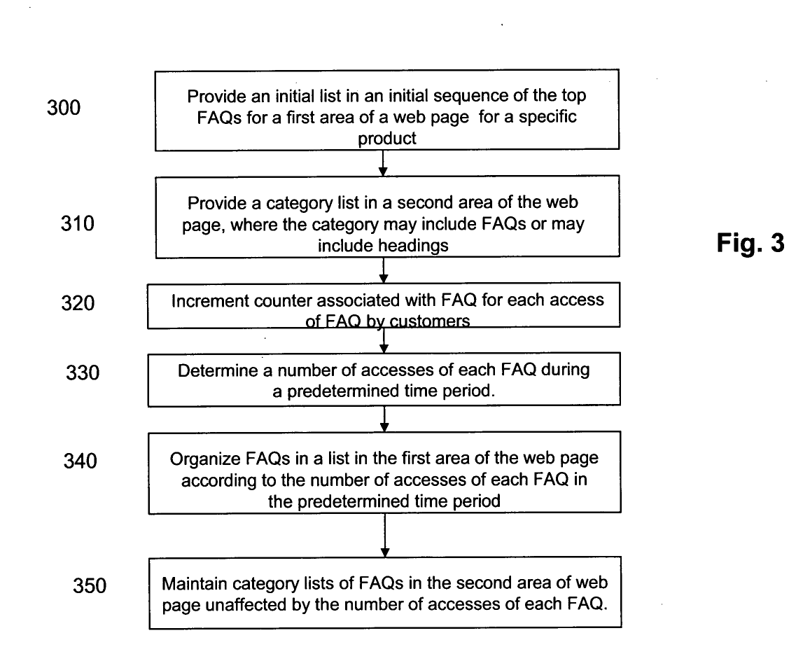

FIG. 3 illustrates a flowchart of operation of a DFAQ system according to an embodiment of the present invention. An initial list with an beginning sequence of the top FAQs may be established 300 in the web page module 138 of the computing device 130. The initial sequence may be based on surveys with customers who have purchased the products, or may be in an order that the manufacturer has determined is appropriate. Under certain operating conditions, the top FAQs may be for a specific product, such as an Epson printer product.

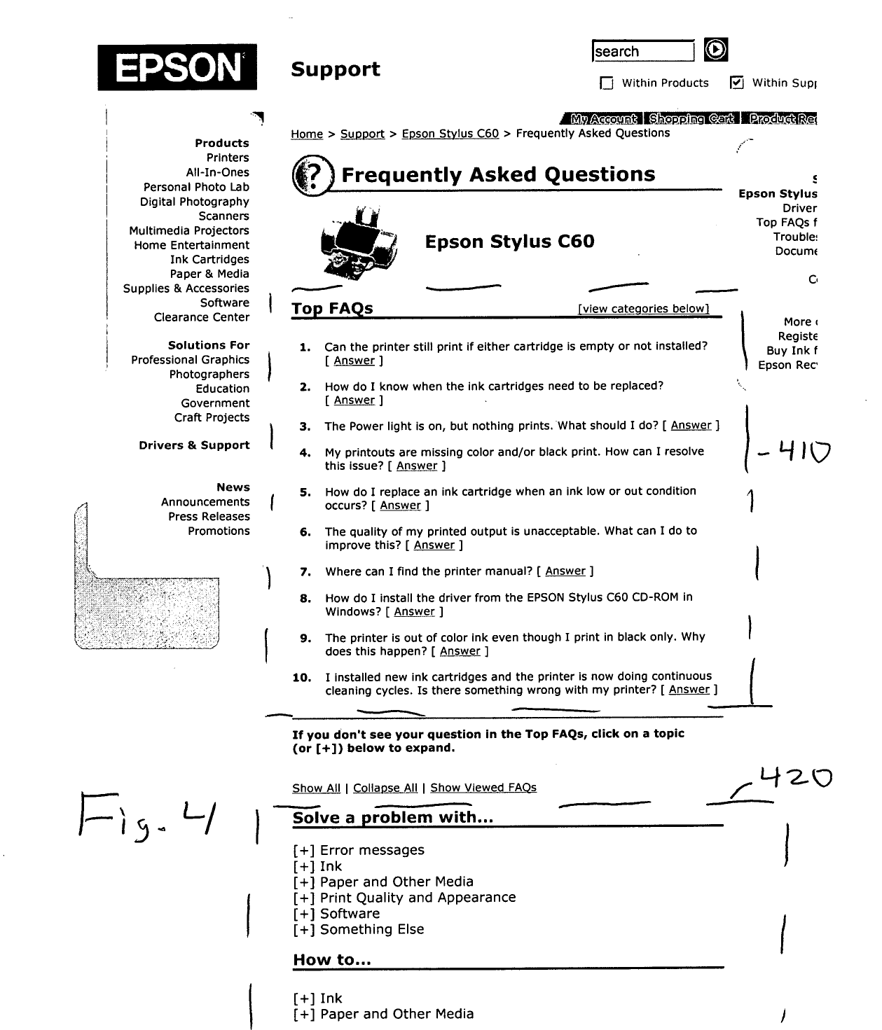

A second area of the web page may be created and stored in the web page module 138, where the second area of the web page lists 310 categories for FAQs. Under other operating conditions, the second area of the web page may list a category heading (which may be non-selectable or accessible) and FAQs which are associated with the categories. FIG. 4 illustrates an Epson web page including a first area 410 with a list of FAQs and a second area 420 including categories.

The customers may then access the web page module 138 via the global communications network. The customers may access specific FAQs on the web page created and established in the web page module 138. Each time a customer (e.g., a customer utilizing a customer computing device) accesses or chooses one of the FAQs on the web page, a counter associated with or corresponding to that FAQ is incremented 320 by one. For example, utilizing the memory table of FIG. 2 as an example, if FAQ 3 is accessed, the number of accesses for FAQ 3 is increment by one.

After a predetermined timeframe, the reorganization module 132 determines 330 the number of accesses for each of the FAQs. The reorganization module 132 reads the values in the memory table 136 or retrieves the values from the memory table 136. The predetermined timeframe may be every two days, every three days, each week, every two weeks, or each month.

The reorganization module 132 creates an updated web page or modifies an existing web page, where the FAQs are organized 340 in the first area of the web page according to the number of accesses of each FAQ that was retrieved from the memory table. The updated web page is then stored in the web page module 138 and is available for access by customers utilizing customer computing devices. The reorganization module 132 maintains 350 category lists of FAQs in the second area of the web page unaffected by the number of accesses of each FAQ. In other words, the reorganization module 132 creates a new, updated, or modified web page and places the category lists in the second area of the web page.

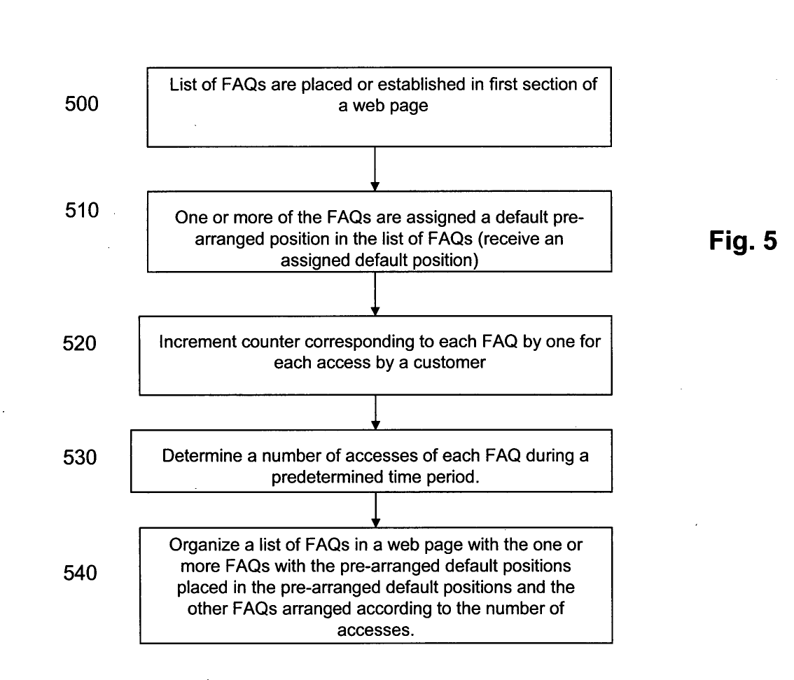

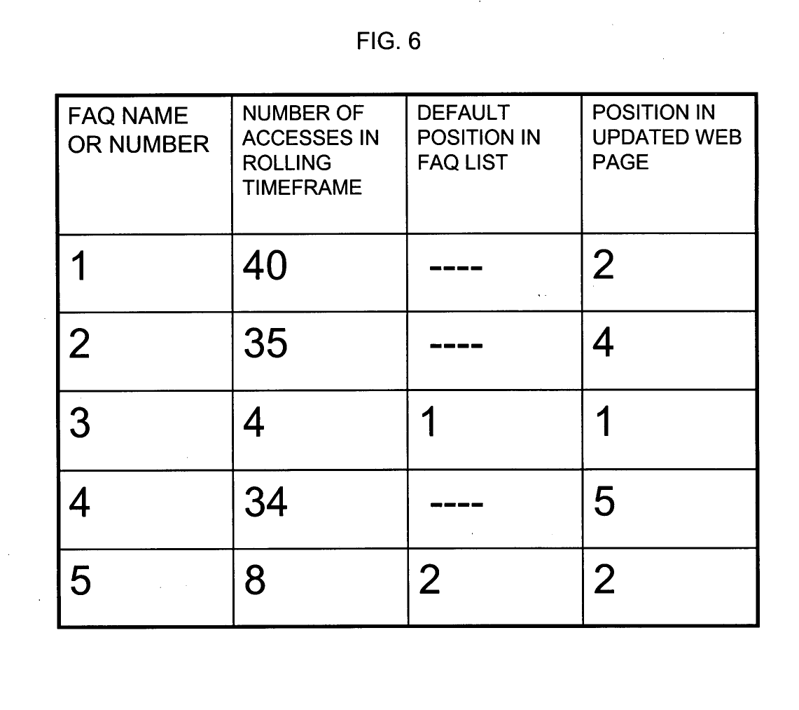

FIG. 5 illustrates operation of a DFAQ system including a default setting position feature according to an embodiment of the present invention. A list of FAQs are established 500 in a first section of a web page. Under certain operating conditions, one or more of the FAQs are assigned 510 a default pre-arranged position in the list of FAQs. The one or more FAQs are assigned a default position by the operator of the DFAQ system. The one or more FAQs may be assigned the default position because the operator of the DFAQ system may want these FAQs to be brought to the attention of the customers who visit the web site of the DFAQ system. In other embodiments of the invention, the reorganization module may be programmed to assign a default position for specific FAQs. For example, a safety issue may arise with a product, such as a baby car seat, so a FAQ (e.g., FAQ3) pertaining to the safety issue may be assigned a first or highest position. In other cases, a new product feature may have a FAQ associated with the new feature. The FAQ (e.g., FAQ5) associated with the new product feature may be assigned a default position of third in the FAQ list. FIG. 6 illustrates a memory table including the default positions or pre-arranged positions.

As the customers, via customer computing devices, access the FAQs in the DFAQ system, counters corresponding to each FAQ are incremented 520 by one for each access. The organization module 132 determines 530 a number of accesses of each FAQ during a predetermined time period. The reorganization module 132 may retrieve the number of accesses from a memory table 136. The reorganization module then creates an updated web page. The updated web page has the list of FAQs organized 540 with the one or more FAQs having pre-assigned default positions being placed in the pre-assigned default positions and the other FAQs arranged according to the number of accesses. Utilizing the memory table illustrated in FIG. 6, the updated web page may place FAQ 3 in an assigned default first position, although it only had once access, and may place FAQ 5 in an assigned default third position.

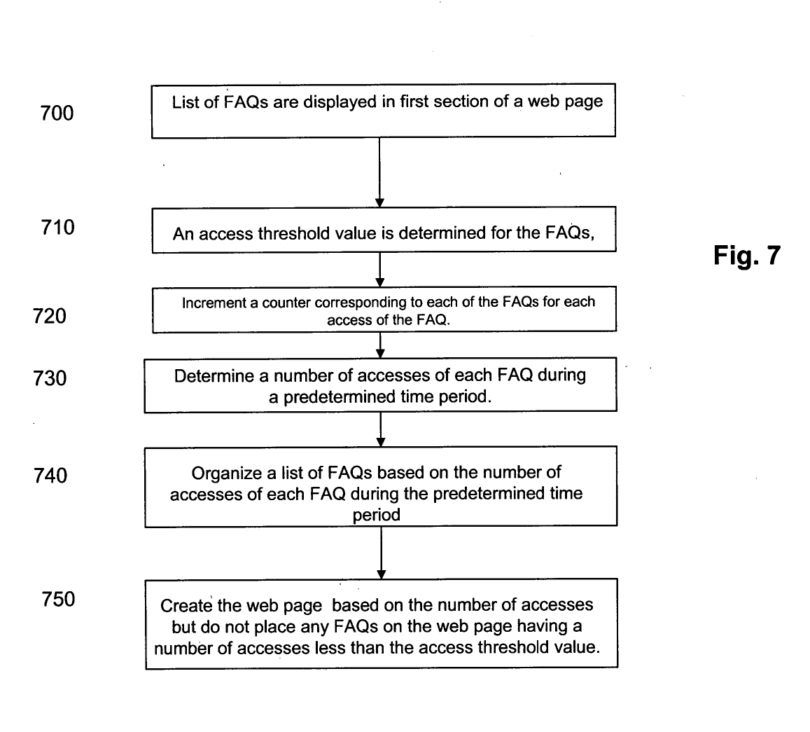

FIG. 7 illustrates a DFAQ system including an access threshold according to an embodiment of the invention. A list of FAQs are displayed 700 in first section of a web page. Under certain operating conditions, an access threshold value is determined 710 for the FAQs. The access threshold value may represent a number of accesses that the operator of the DFAQ system may not consider relevant. Under certain operating conditions, the access threshold may be manually entered or may be automatically generated or calculated by the DFAQ system. Illustratively, the DFAQ system may be programmed to not list two of the FAQs and may calculate the access threshold based on this. For example, if one FAQ is only accessed 5 times during a two-week timeframe, the DFAQ system operator may not desire to keep from posting this FAQ on the updated web page.

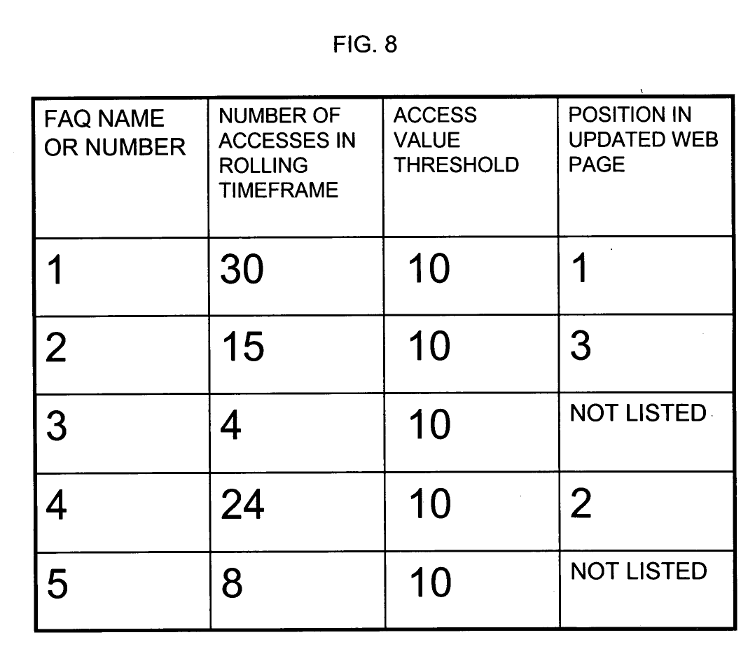

Each time a FAQ is accessed, a counter corresponding to the accessed FAQ is incremented 720 by one. The reorganization module 132 determines 730 a number of accesses of each FAQ during a predetermined time period. For example, the predetermined time period may be two weeks or one month. FIG. 8 illustrates a memory table 138 including an access threshold according to an embodiment of the present invention. In FIG. 8, the access threshold is 10.

The reorganization module 132 organizes 740 a list of FAQs based on the number of accesses of each FAQ during the predetermined time period. The reorganization module 750 creates or generates an updated web page based on the number of accesses for each FAQ but does not place any FAQs on the updated web page having a number of accesses less than the access threshold value. The reorganization module 132 may compare the number of accesses for each of the FAQs to the access value threshold. For example, utilizing the memory table illustrated in FIG. 8, the reorganization module 132 may generate an updated web page only including FAQs 1, 2, and 4, because FAQs 3 and 5 did not exceed the access value threshold. In this example, the reorganization module compared FAQs 3 and 5 to the access threshold value and each of FAQ 3 and 5 accesses was less than 10.

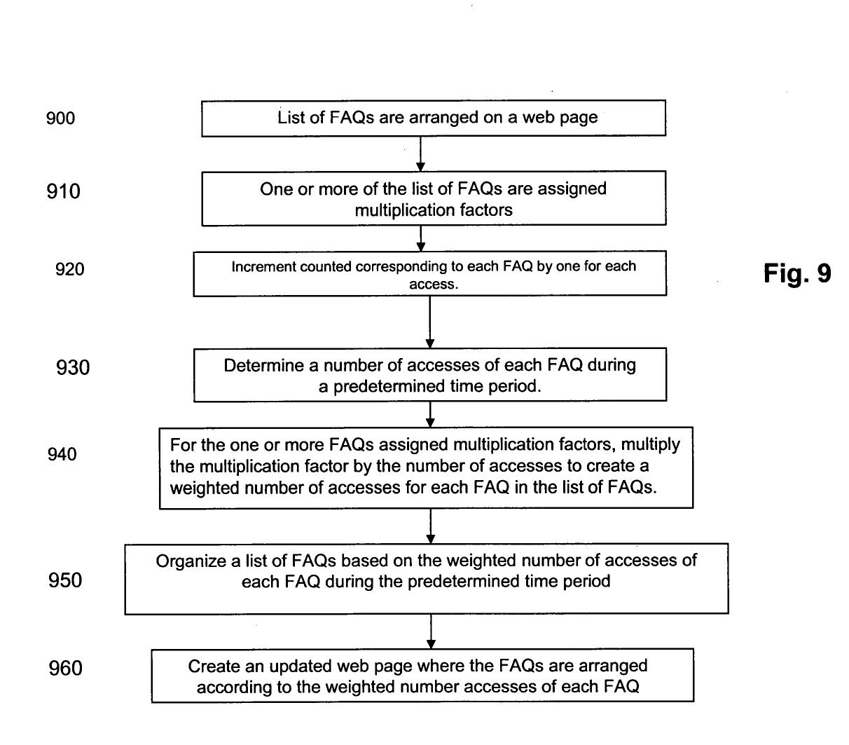

FIG. 9 illustrates a DFAQ system including a weighting factor according to an embodiment of the present invention. A list of FAQs are arranged 900 on a web page. One or more of the list of FAQs are assigned 910 multiplication factors. The assigning of multiplication factors may be performed manually or may be automatically calculated or generated by the DFAQ system. The operator of the DFAQ system may decide that certain ones of the list of FAQs should be listed higher on the list of FAQs than the actual accesses the FAQ has received. A counter corresponding to each FAQ in the FAQ list is incremented 920 by one for each access of a FAQ by a customer computing device.

The reorganization module 132 determines 930 a number of accesses of each FAQ during a predetermined time period. For the one or more FAQs assigned multiplication factors, the reorganization module 132 multiplies 940 a multiplication factor by the number of accesses to create a weighted number of accesses for each FAQ in the list of FAQs. If no weighting factor is assigned, under certain operating conditions, a weighting factor of one is assigned. The reorganization module 132 organizes 950 the list of FAQs based on the weighted number of accesses of each FAQ during the predetermined time period. The reorganization module 132 creates or generates 960 an updated web page where the FAQs are arranged according to the weighted number accesses of each FAQ and any FAQ without a weighting factor is arranged according to number of accesses.

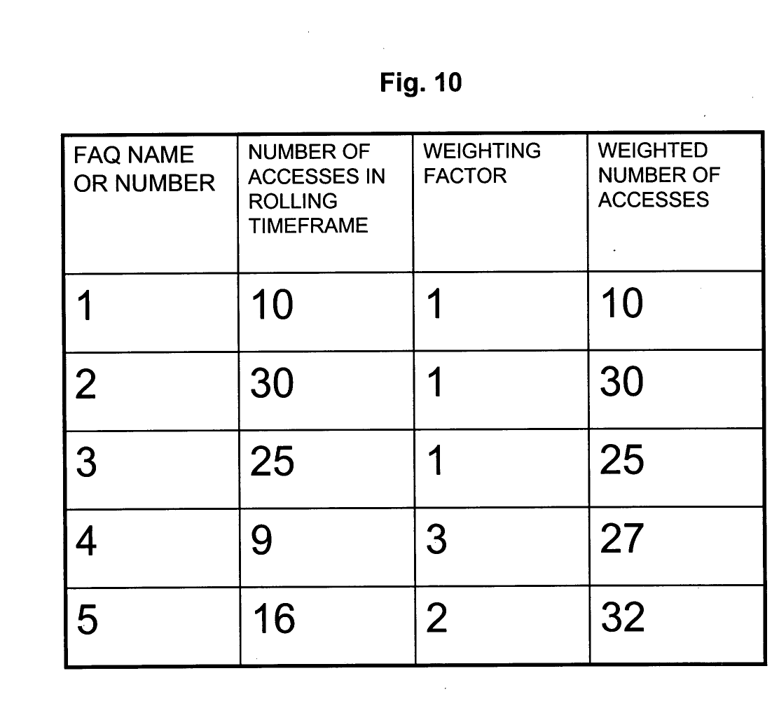

Utilizing the memory table illustrated in FIG. 10, although FAQs 4 and 5 had only 9 and 16 accesses, respectively, the weighting factors associated with FAQ 4 (weighting factor of 3) and FAQ 5 (weighting factor of 2) resulted in weighted number of access of 27 and 32, respectively. Accordingly, a reorganization module 132 would create an updated web page having FAQ 5 listed first and FAQ 4 listed third in the updated web page due to the weighting factor.

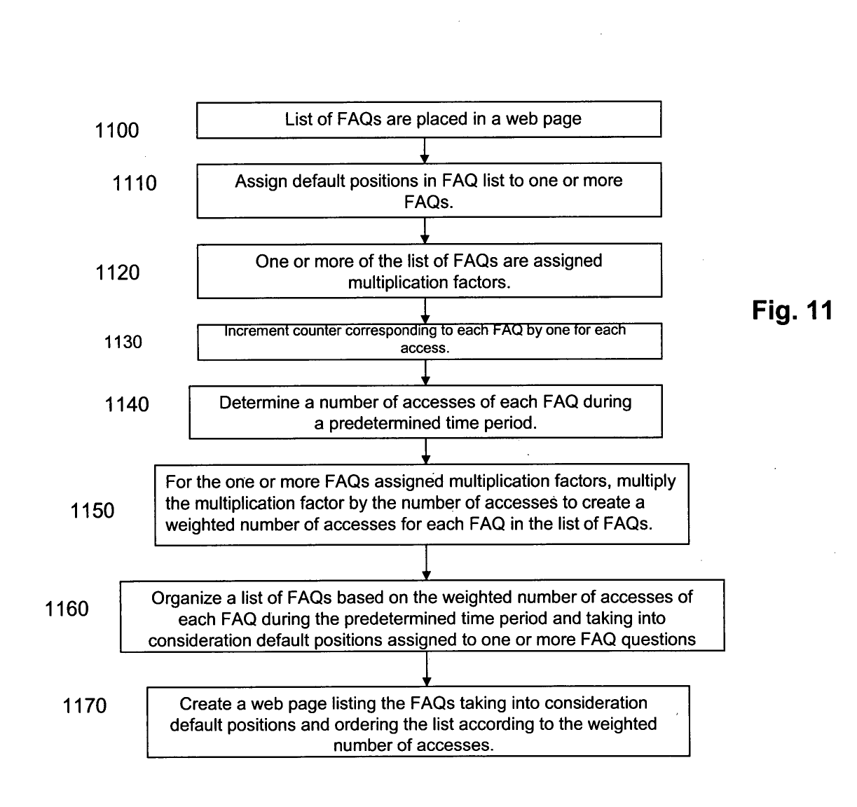

FIG. 11 illustrates a DFAQ system including default positions and weighted number of accesses according to an embodiment of the invention. The DFAQ system may include any of the previous disclosed embodiments of FIG. 5, FIG. 7, and FIG. 9. Illustratively, default positions may be combined with weighted accesses. In another DFAQ system, the access value threshold may be combined with the default position. A list of FAQs are placed 1100 in a web page in a computing device operated by the DFAQ system operator. As discussed above, a DFAQ system operator may assign 1110 default positions to one or more FAQs in the FAQ list. Also, as discussed above, one or more of the list of FAQs may be assigned 1120 multiplication factors. Under certain operating conditions, a single FAQ listing may be assigned a both a default position and a multiplication factor.

As each FAQ is accessed by customer computing devices, a counter corresponding to the accessed FAQ is incremented 1130 by one for each access. The reorganization module 132 of the DFAQ system may determine 1140 a number of accesses of each FAQ during a predetermined time period. As noted above, the reorganization module 132 of the DFAQ system may access a memory table 136 to retrieve the number of accesses.

The reorganization module 132, for each of the one or more FAQs assigned multiplication factors, multiplies 1150 the assigned multiplication factor by the retrieved number of accesses to create a weighted number of accesses. The reorganization module 132 may organize 1160 the list of FAQs based on the weighted number of accesses of each FAQ during the predetermined time period, but the reorganization module 132 also takes into consideration of the default positions assigned to one or more FAQ questions. The reorganization module 132 may create or generate 1170 an updated web page, where the updated web page organizes the FAQs according to the weighted number accesses of each FAQ and takes into consideration the assigned default positions for certain FAQs.

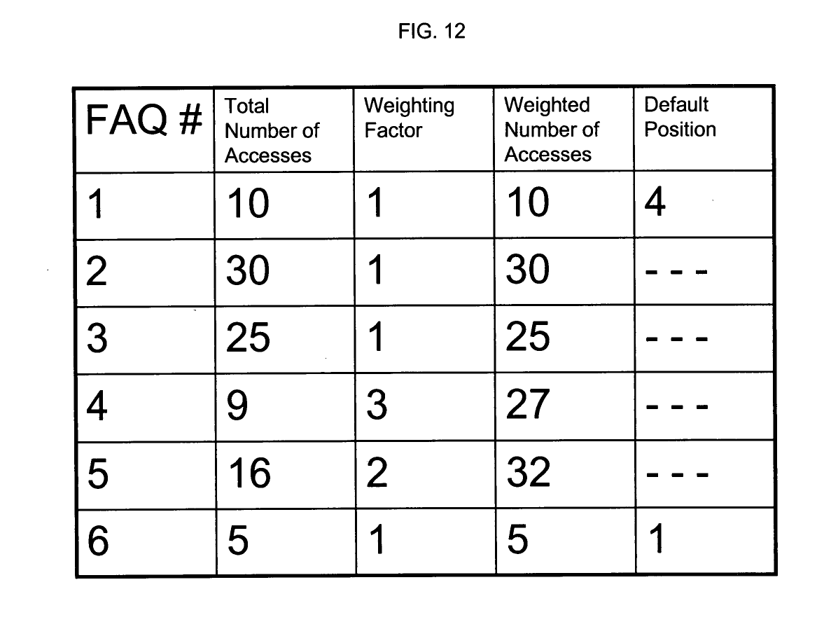

For example, utilizing the memory table illustrated in FIG. 12, FAQ 6, although having the least number of accesses, is listed first because of being assigned the default position of 1. FAQ 5 is listed next because of the weighting factor which doubles the number of accesses from 16 to 32. FAQ 2 is listed next, i.e., third, even though it has the highest number of actual accesses (30). FAQ 1 is listed next because it is assigned a default position of 4. FAQ 4 is listed next and FAQ 3 is listed last.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. An executable code storage device, comprising:
a machine readable storage medium; and
machine-readable program code, stored on the machine-readable storage medium, the machine readable program code having instructions, which when executed cause a computing device to:
increment a plurality of counters, each of the plurality of counters being incremented when a corresponding frequently asked question (FAQ) of a plurality of frequently asked questions (FAQs) is accessed;
determine a number of accesses for each of the plurality of FAQs;
create a web page listing the plurality of FAQs in an order based on the number of accesses for each of the plurality of FAQs; and
create a category listing on the web page where the category listing identifies categories of questions corresponding to the plurality of FAQs.

2. The executable code storage device of claim 1, wherein the computing devices is a server.

3. The executable code storage device of claim 1, wherein the web page is created utilizing Extensible Markup Language (XML).

4. The executable code storage device of claim 1, wherein the web page is created utilizing Hyptertext Markup Language (HTML).

5. An executable code storage device, comprising:
a machine readable storage medium; and
machine-readable program code, stored on the machine-readable storage medium, the machine readable program code having instructions, which when executed cause a computing device to:
increment a plurality of counters, each of the plurality of counters being incremented when a corresponding frequently asked question (FAQ) of a plurality of frequently asked questions (FAQs) is accessed;
receive a weighting factor to a first FAQ of the plurality of FAQs
determine a number of accesses for each of the plurality of FAQs; and
multiply the weighting factor of the first FAQ by the number of accesses for the first FAQ to determine a weighted number of accesses for the first FAQ.

6. The executable code storage device of claim 5, including instructions, which when executed, cause the computing device to
create a web page listing the plurality of FAQs in an order determined by the weighted number of accesses for the first FAQ and the number of accesses for each remaining FAQ of the plurality of FAQs.

7. The executable code storage device of claim 5, including instructions, which when executed, cause the computing device:
receive a second weighting factor to a second FAQ of the plurality of FAQs,
multiply the weighting factor of the second FAQ by the number of accesses of the second FAQ to determine a weighted number of accesses for the second FAQ, and
create a web page listing the plurality of FAQs in an order determined by the weighted number of accesses for the first FAQ and the second FAQ and the number of accesses for each remaining FAQ of the plurality of FAQs.

8. The executable code storage device of claim 7, wherein the first weighting factor is equal to the second weighting factor.

9. An executable code storage device, comprising:
a machine-readable storage medium; and
machine-readable program code, stored on the machine-readable storage medium, the machine-readable program code having instructions, which when executed cause a computing device to:
increment a plurality of counters, each of the plurality of counters being incremented when a corresponding frequently asked question (FAQ) of a plurality of frequently asked questions (FAQS) is accessed;
receive a default position to a first FAQ of the plurality of FAQs; and
determine a number of accesses for each of the plurality of FAQs.

10. The executable code storage device of claim 9, including instructions which when executed cause the computing device to:
create a web page listing the plurality of FAQs in an order where the first FAQ is listed in the default position assigned to the first FAQ and the number of accesses for each remaining FAQ of the plurality of FAQs determines in which position each remaining FAQ is listed on the web page.

11. The executable code storage device of claim 9, including instructions, which when executed, cause the computing device to
receive a default position to a second FAQ of the plurality of FAQs, and
create the web page listing the plurality of FAQs in an order where the first FAQ and the second FAQ are listed in the default position assigned to the first FAQ and the second FAQ, respectively, and remaining FAQs of the plurality of FAQs are listed based on the number of accesses for the remaining FAQs.

12. The executable code storage device of claim 9, including instructions, which when executed, cause the computing device to
receive a weighting factor to a second FAQ of the plurality of FAQs;
multiply the weighting factor of the second FAQ by the number of accesses for the second FAQ to determine a weighted number of accesses for the second FAQ.

13. The executable code storage device of claim 12, including instructions, which when executed, cause the computing device to
create a web page listing the plurality of FAQs where the first FAQ is listed in the assigned default position, the second FAQ is listed according to a weighted number of accesses, and remaining FAQs are listed based on the number of accesses for each the remaining FAQs.

14. An executable code storage device, comprising:
a machine-readable storage medium; and
machine-readable program code, stored on the machine-readable storage medium, the machine-readable program code having instructions, which when executed cause a computing device to:
increment a plurality of counters, each of the plurality of counters being incremented when a corresponding frequently asked question (FAQ) of a plurality of frequently asked questions (FAQs) is accessed;
receive an access value threshold for the plurality of FAQs;
determine a number of accesses for each of the plurality of FAQs; and
compare, for each of the plurality of FAQs, the number of accesses to the access value threshold.

15. The executable code storage device of claim 14, including instructions, which when executed, cause the computing device to
create a web page listing each of the plurality of FAQs unless a FAQ has a number of accesses less than the access value threshold.

16. The executable storage device of claim 14, including instructions, which when executed, cause the computing device to
receive a weighting factor to a first FAQ of the plurality of FAQs;
multiply the weighting factor of the first FAQ by the number of accesses for the first FAQ to determine a weighted number of accesses for the first FAQ; and
compare the weighted number of accesses to the access value threshold.

17. The executable storage device of claim 16, including instructions, which when executed, cause the computing device to
create a web page listing the each of the plurality of FAQs unless a FAQ has a number of accesses or a weighted number of accesses less than the access value threshold.

18. The executable storage device of claim 14, including instructions, which when executed cause the computing device to
receive a default position to a first FAQ of the plurality of FAQs;

19. The executable storage device of claim 14, including instructions, which when executed cause the computing device to
create a web page listing the first FAQ in the assigned default position and listing each remaining FAQ of the plurality of FAQs unless a FAQ has a number of accesses which is less than the access value threshold.

20. The executable code storage device of claim 19, wherein the web page is created in Extensible Markup Language (XML).
